(19) United States
(12) Patent Application Publication
(10) Pub. No.: US 2026/0186310 A1
(43) Pub. Date: Jul. 2, 2026

(54) OPTICAL APPARATUS

(71) Applicant: Nokia Technologies Oy, Espoo (FI)

(72) Inventors: Marja Pauliina SALMIMAA, Tampere (FI); Toni Johan JÄRVENPÄÄ, Tampere (FI)

(21) Appl. No.: 19/425,508

(22) Filed: Dec. 18, 2025

(30) Foreign Application Priority Data
Dec. 27, 2024 (GB) 2419093.6

(51) Int. Cl. G02B 27/01; G02B 6/42

(52) U.S. Cl. CPC G02B 27/0179; G02B 6/4214; G02B 27/0101

(57) ABSTRACT

Examples of the disclosure relate to optical apparatus that enable tracking of a user of the apparatus. The apparatus comprises a light guide arranged to enable light to be guided through the light guide via internal reflections, first in-coupling diffractive means configured to in-couple one or more input beams of light with a first wavelength range into the light guide, second in-coupling diffractive means configured to in-couple one or more input beams of light with a second wavelength range into the light guide, expanding diffractive means configured to expand the one or more input beams of light, and out-coupling diffractive means configured to out-couple the expanded beams of light from the light guide so as to provide a first exit pupil for the first wavelength range and a second exit pupil for the second wavelength range.

### TECHNOLOGICAL FIELD

Examples of the disclosure relate to optical apparatus, modules and devices. Some relate to optical apparatus, modules and devices for providing a more uniform output.

### BACKGROUND

Optical apparatus, such as exit pupil expanders, can be used in display systems and devices such as near eye displays, augmented and/or virtual reality headsets and head up displays for example. Colour uniformity can be difficult to achieve in such devices.

### BRIEF SUMMARY

According to various, but not necessarily all, examples of the disclosure, there is provided an apparatus comprising:
a light guiding member comprising a stack of layers and multiple interfaces between respective layers, wherein the respective layers are arranged to enable light to be guided through the light guiding member via internal reflections;
first in-coupling diffractive means configured to in-couple one or more input beams of light into the light guiding member;
expanding diffractive means configured to expand the one or more input beams of light,
out-coupling diffractive means configured to out-couple the one or more beams of light from the light guiding member wherein the first in-coupling diffractive means and the out-coupling diffractive means are provided on a first layer of the stack of layers; and
second in-coupling diffractive means configured to in-couple one or more input beams of light that has passed through the stack of layers into the light guiding member and wherein the second in-coupling diffractive means is provided on a different layer of the stack of layers to the first layer.

The second in-coupling diffractive means may be provided on an opposing surface of the stack of layers to the first in-coupling diffractive means and the second in-coupling diffractive means is positioned so that the second in-coupling diffractive means at least partially overlaps the first in-coupling diffractive means.

The stack of layers may comprise at least two layers and the first in-coupling diffractive means is provided on a first layer of the light guiding member and the second in-coupling diffractive means is provided on a last layer.

The first in-coupling diffractive means and the second in-coupling diffractive means may have the same period.

The first in-coupling diffractive means may be configured to in-couple light with a first wavelength range and the second in-coupling diffractive means is configured to in-couple light with a second wavelength range.

At least one of the multiple interfaces may be configured to reflect light in a first wavelength range and allow light in a second wavelength range to pass through.

A thin film material may be provided at the interfaces.

Different layers in the stack of layers may have different thicknesses.

The first layer may be thinner than other layers in the stack of layers.

The light guiding member may be one of:
substantially planar;
curved.

The interfaces between respective layers of the light guiding member may be one of:
substantially planar;
curved.

According to various, but not necessarily all, examples of the disclosure, there is provided a module, a device, a headset, a vehicle or cab for a vehicle comprising an apparatus as described herein.

According to various, but not necessarily all, embodiments there is provided an apparatus comprising
at least one processor; and
at least one memory including computer program code;
the at least one memory storing instructions that, when executed by the at least one processor, cause the apparatus to perform at least a part of one or more methods described herein.

According to various, but not necessarily all, embodiments there is provided an apparatus comprising means for performing at least part of one or more methods described herein. The description of a function and/or action should additionally be considered to also disclose any means suitable for performing that function and/or action. Functions and/or actions described herein can be performed in any suitable way using any suitable method.

According to various, but not necessarily all, embodiments there is provided examples as claimed in the appended claims.

While the above examples of the disclosure and optional features are described separately, it is to be understood that their provision in all possible combinations and permutations is contained within the disclosure. It is to be understood that various examples of the disclosure can comprise any or all the features described in respect of other examples of the disclosure, and vice versa. Also, it is to be appreciated that any one or more or all the features, in any combination, may be implemented by/comprised in/performable by an apparatus, a method, and/or computer program instructions as desired, and as appropriate. The description of a function should additionally be considered to also disclose any means suitable for performing that function

### BRIEF DESCRIPTION

Some examples will now be described with reference to the accompanying drawings in which:

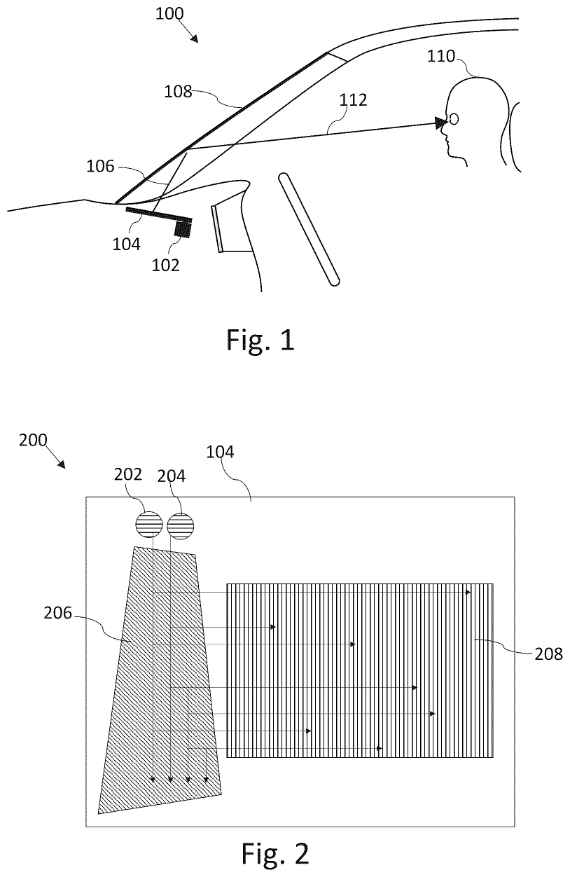

FIG. 1 shows an example apparatus;

FIG. 2 shows a cross section of an example apparatus;

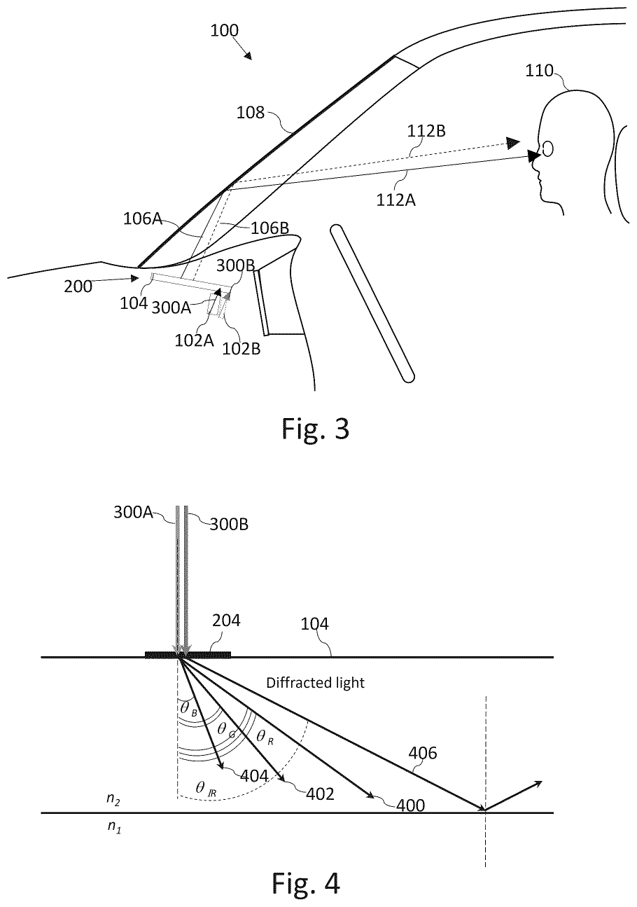

FIGS. 3A to 3C show in-coupling of different wavelengths of light into an example apparatus;

FIGS. 4A to 4C show an optical path for an example apparatus;

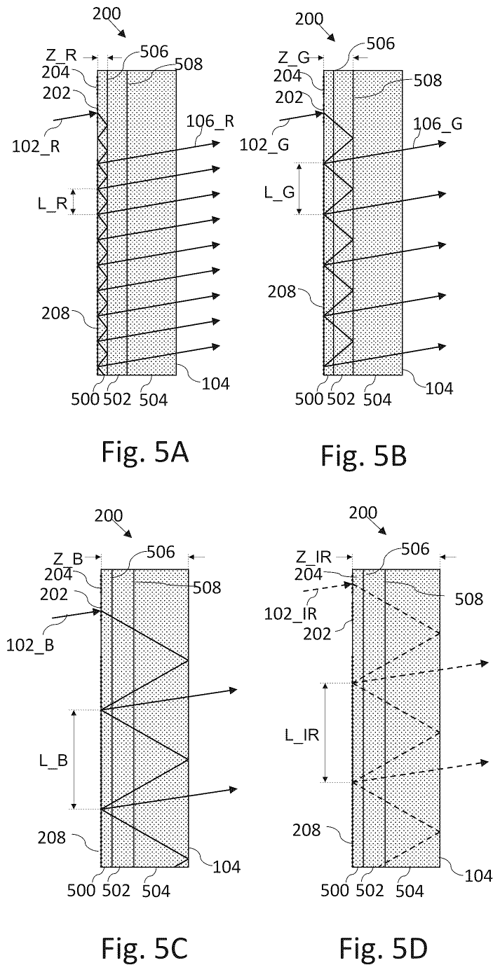

FIGS. 5A to 5C show an optical path for an example apparatus;

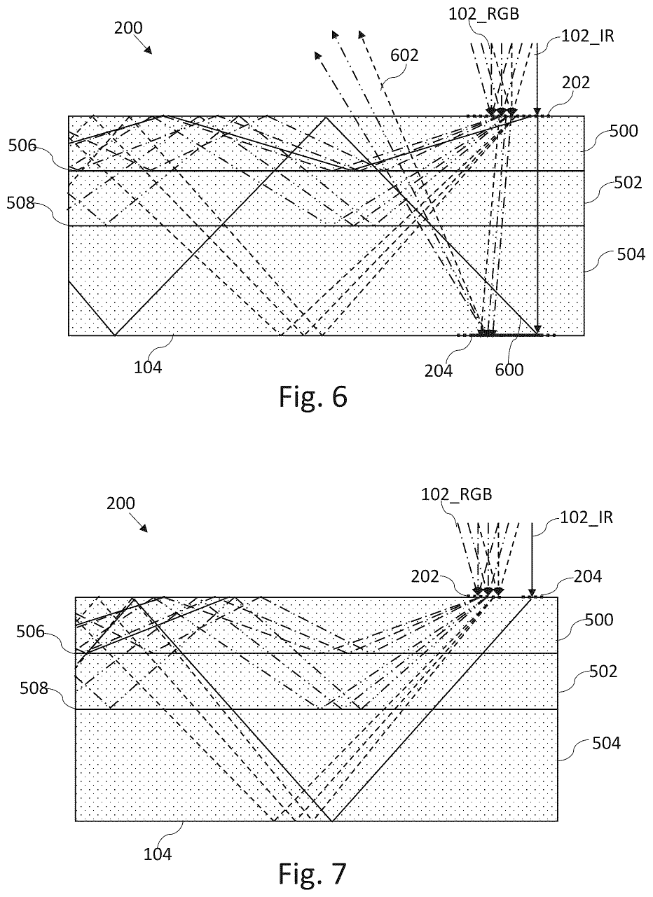

FIGS. 6A to 6C show an optical path for an example apparatus;

FIGS. 7A to 7C show an optical path for an example apparatus;

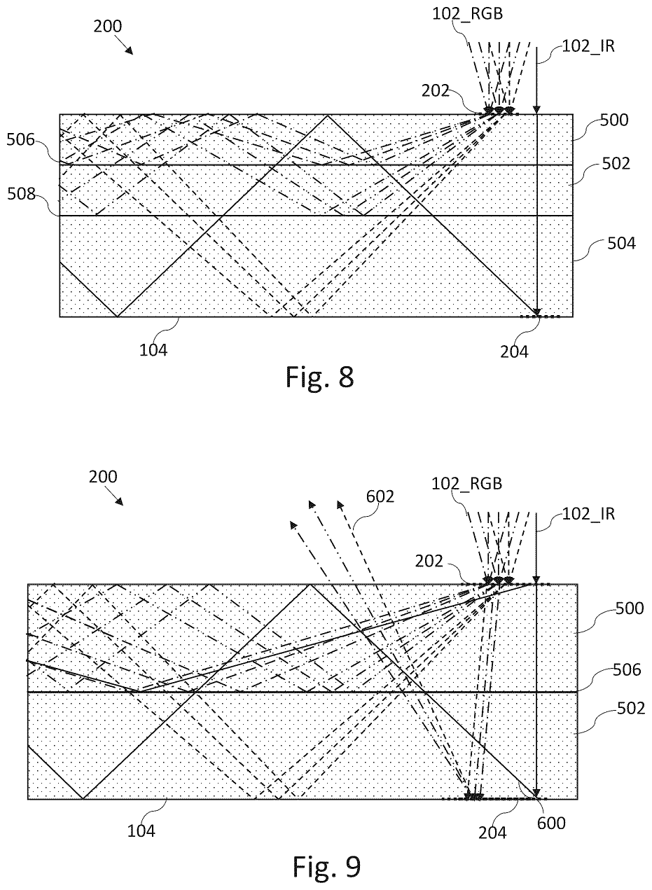

FIG. 8 shows an example grating profile;

FIGS. 9A to 9E show grating profile examples; and

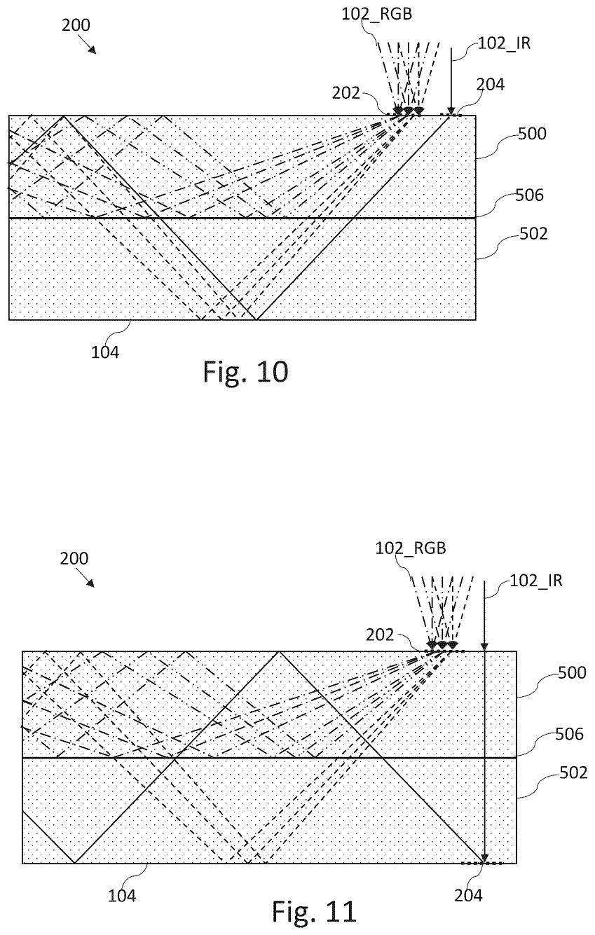

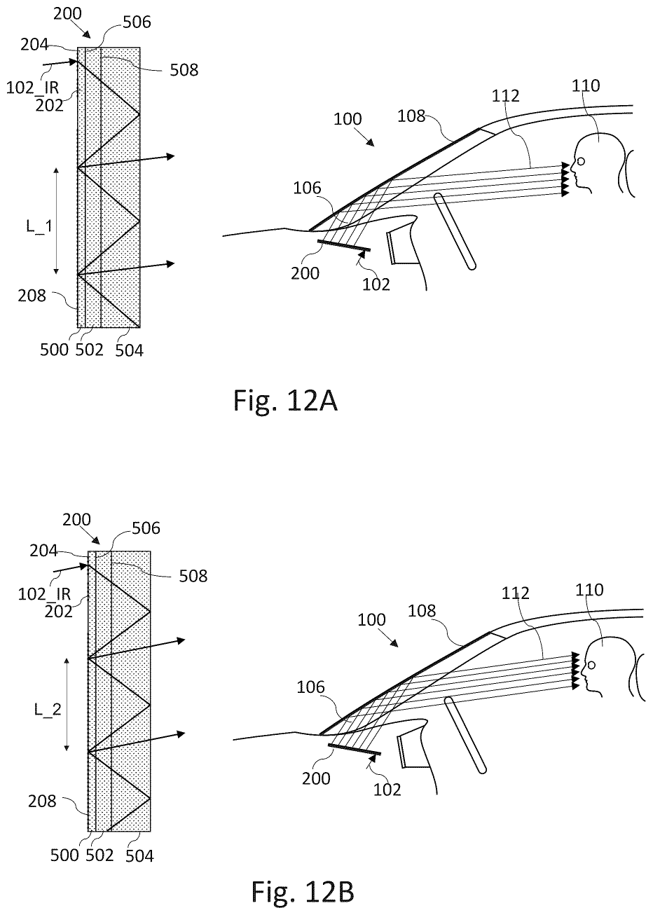

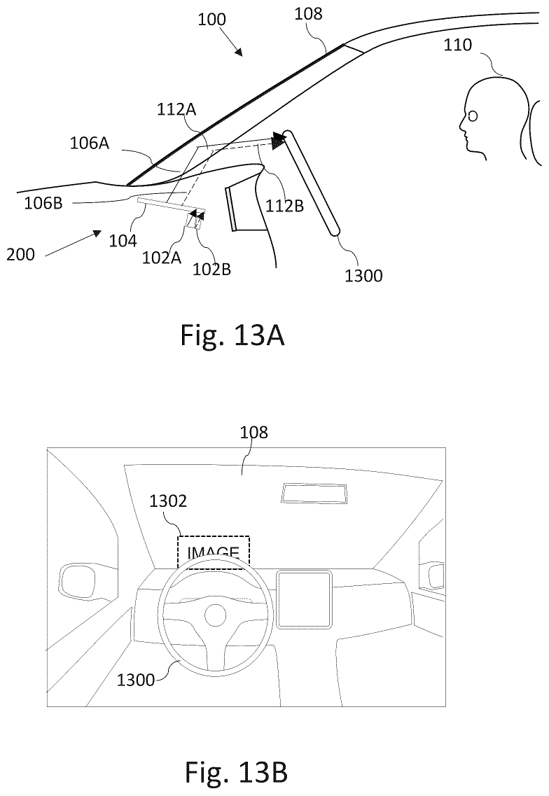

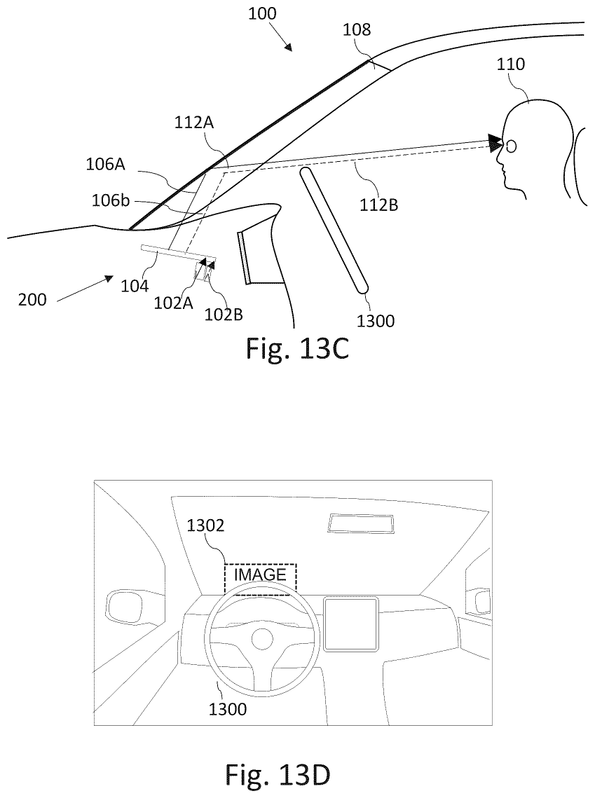

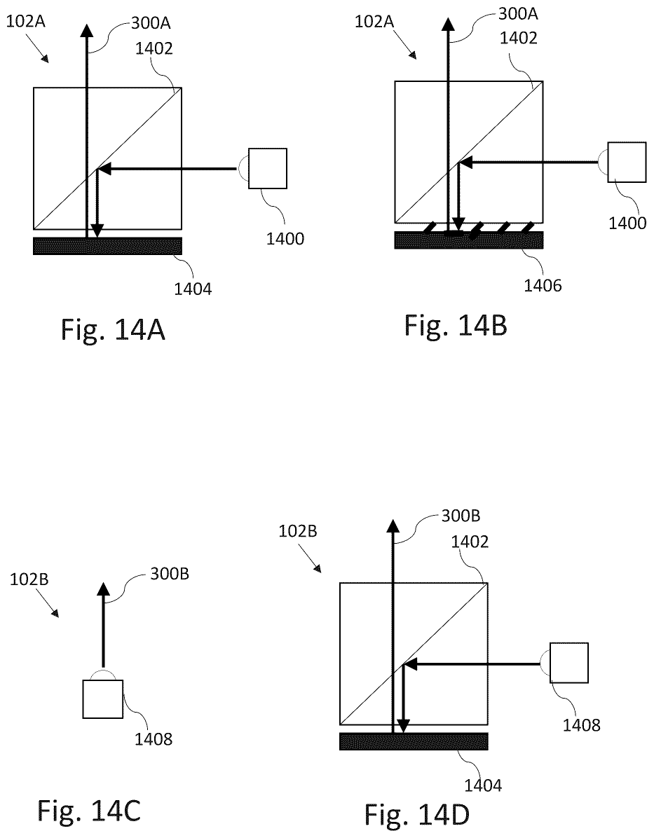

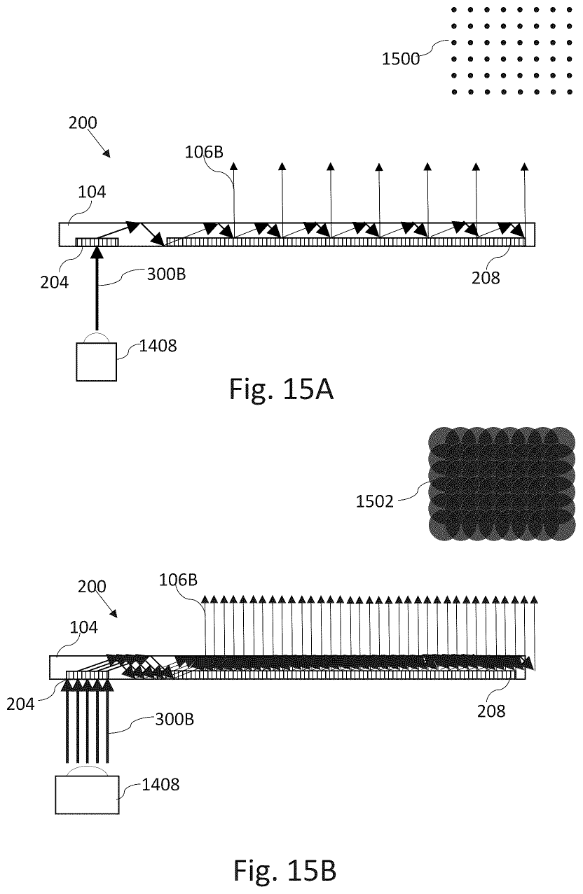

FIG. 10 shows an example luminance distribution.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Corresponding reference numerals are used in the figures to designate corresponding features. For clarity, all reference numerals are not necessarily displayed in all figures.

### DETAILED DESCRIPTION

Optical apparatus comprising diffractive optics can be used in devices such as mediated headsets or vehicular displays. In an ideal light guiding apparatus the output would have uniform brightness for different wavelengths of light. This can be difficult to achieve in practice.

Also in such devices, if there is not sufficient overlap of exit pupils this can result in fringing or dark bands in the output. This is undesirable.

Examples of the disclosure provide optical apparatus that address these issues.

FIG. 1 shows an example apparatus 100. The apparatus 100 could be provided in a module, a device, a headset, a vehicle or cab for a vehicle or for any other suitable use.

The apparatus 100 comprises a light guiding member 102. In this example the light guiding means 102 comprises an exit pupil expander. The exit pupil expander is configured to replicate an exit pupil from a light engine or other optical arrangement. The light engine could be a display means such as a light engine, projection engine, or a picture generating unit.

The light guiding member 102 comprises a stack of layers 104. The stack of layers 104 comprises multiple layers and multiple interfaces 106 between respective layers. The respective layers are arranged to enable light to be guided through the light guiding member 102 via internal reflections. In the example of FIG. 1 the light guiding member 102 comprises three layers. The light guiding member 102 can comprise other numbers of layers in other examples. The stack of layers 104 can comprise at least two layers.

In the example of FIG. 1 the light guiding member 102 is substantially planar. The respective layers within the light guiding member 102 can be planar or substantially planar. The interfaces 106 between respective layers of the light guiding member 102 can be planar or substantially planar.

The apparatus 100 also comprises a first in-coupling diffractive means 108, an expanding diffractive means 110, an out-coupling diffractive means 112 and a second in-coupling diffractive means 114.

The respective diffractive means can comprise any means that can be configured to diffract the input beams of light. The diffractive means can comprise any one or more of a diffractive optical element, diffractive structure, diffraction gratings, holographic gratings, Bragg gratings, rulings, ridges, surface relief diffractive gratings or any suitable optical component or feature having a periodic structure that splits and diffracts light into several beams travelling in different directions.

The first in-coupling diffractive means 108 is configured to in-couple one or more input beams of light into the light guiding member 102. The first in-coupling diffractive means 108 can be configured to in-couple one or more input beams of light into the first layer of the light guiding member 102.

The input beams of light can be provided from a light engine or any other suitable source. The first in-coupling diffractive means 108 is positioned within the light guiding means 102 so that, in use, the first in-coupling diffractive means 108 can be positioned adjacent to a light engine, picture generating unit, or any other suitable source.

The expanding diffractive means 110 is configured to expand the one or more input beams of light in at least one dimension. In the expanding diffractive means 110 the in-coupled beam of light is split into two with every interaction with the expanding diffractive means 110. The interaction could be, for example, an internal reflection. The split sections of the beam travel in different directions and continue splitting and so expand the exit pupil of the input beam of light.

The out-coupling diffractive means 112 is configured to out-couple the one or more beams of light from the light guiding member 102. The out-coupling diffractive means 112 can function in a similar manner to the expanding diffractive means 110 so that the expanded beam of light is split into two with every interaction with the out-coupling diffractive means 112. The out-coupling diffractive means 112 can be configured to expand the beam of light in a second dimension where the second dimension is perpendicular, or substantially perpendicular, to a dimension for which the expanding diffractive means expands the beam of light.

The first in-coupling diffractive means 108, the expanding diffractive means 110 and the out-coupling diffractive means 112 are provided on the first layer of the light guiding member 102.

The second in-coupling diffractive means 114 is configured to in-couple one or more input beams of light that have passed through the stack of layers 104 into the light guiding member 102.

The second in-coupling diffractive means 114 is provided on a different layer of the stack of layers 104 to the first in-coupling diffractive means 108. In the example shown, the first in-coupling diffractive means 108 is provided on the first layer of the light guiding member 102 and the second in-coupling diffractive means 114 is provided on the third layer or the last layer of the stack of layers 104.

The second in-coupling diffractive means 114 can be provided on an opposing surface of the stack of layers 104 to the first in-coupling diffractive means 108 and the second in-coupling diffractive means 114 is positioned so that the second in-coupling diffractive means 114 at least partially overlaps the first in-coupling diffractive means 108.

The first in-coupling diffractive means 108 and the second in-coupling diffractive means 114 can have the same period. Other parameters of the first in-coupling diffractive means 108 and the second in-coupling diffractive means 114 can be different. This can enable the different in-coupling diffractive means 108, 114 to in-couple light at different efficiencies. For example, the first in-coupling diffractive means 108 can be configured to in-couple light with a first wavelength range and the second in-coupling diffractive means 114 can be configured to in-couple light with a second wavelength range. The second wavelength range can be different to the first wavelength range. The second wavelength range can comprise shorter wavelengths than the first wavelength range. For example, the first wavelength range can comprise red and green light and the second wavelength range can comprise blue light.

As mentioned above, some parameters of the respective in-coupling diffractive means 108, 114 can be different. These parameters can comprise the profile of the gratings or parameters such as depth modulation, fill ratio, materials, slant angle or other suitable parameters or combinations of parameters.

One or more of the interfaces 106 between the respective layers of the light guiding member 102 can be configured to reflect light in the first wavelength range and allow light in the second wavelength range to pass through. This allows the light in the second wavelength range to pass through the stack of layers 104 to reach the second in-coupling diffractive means 114.

In some examples a thin film material can be provided at one or more of the interfaces 106. Different thin film materials can be used at different interfaces 106. This can enable different interfaces to allow light with different wavelengths and different angles of incidence to pass through. The thin film materials that are used in the interfaces 106 can be selected to provide appropriate optical properties. The thin film material can be selected to enable light of at least the second wavelength range with an appropriate angle of incidence to pass through. The thin film material can be selected to have a refractive index that is low enough to support total internal reflection for light in the first wavelength range.

The thickness of the thin film material can be substantially larger than the wavelength of the light to reduce any light leakage through frustrated total internal reflection.

The thin film materials can be chemically compatible with the surrounding materials. For example, adhesion properties between the thin film materials and adjacent layers should be strong enough so that the layers of the stack 104 will not delaminate over the operating conditions.

Any suitable material can be used for the layers within the stack of layers 104. The materials that are used for the layers have to provide for total internal reflection. In addition to this the materials for the layers can be selected so that they will not cause substantial optical absorption or scattering for the light of the wavelengths of interest. In addition to this the materials used for the layers can be selected to provide good mechanical strength. In some examples different materials can be used for different layers of the stack 104. The different materials can have different optical properties.

In the example shown in FIG. 1 the different layers within the stack of layers 104 each have the same thickness. In other examples different layers within the stack of layers 104 have different thicknesses. For example, the first layer could be thinner than other layers within the stack of layers 104.

In the examples shown in FIG. 1 the light guiding member 102 is planar or substantially planar. In other examples the light guiding member 102 could be curved. Similarly, in FIG. 1 the interfaces 106 between respective layers of the light guiding member 102 are planar or substantially planar. In other examples the interfaces 106 between respective layers of the light guiding member 102 could be curved.

FIG. 2 shows a cross section of an example apparatus 100. This could be the apparatus 100 as shown in FIG. 1. The expanding diffractive means 110 and the out-coupling diffractive means 112 are not shown in FIG. 2. These could be provided on the same surface of the first in-coupling diffractive means 108.

FIG. 2 shows an input beam of light 200. The input beam of light 200 can be provided by a light engine or other optical arrangement.

The input beam of light 200 is incident on the first in-coupling diffractive means 108. The input beam of light 200 can comprise light if different wavelength ranges. In this example the input beam of light 200 can comprise red light, green light and blue light. The red light and green light can comprise a first wavelength range and the blue light can comprise a second wavelength range. Other wavelengths of light and ranges of wavelengths of light can be used in other examples.

The first in-coupling diffractive means 108 diffracts the input beam of light 200. The diffracted light has multiple orders. The first in-coupling diffractive means 108 is configured so that, at least part of, the first (T₁) order is diffracted to an angle to enable total internal reflection within the light guiding member 102. Different components of the T₁ order are shown in FIG. 2. In this example the red component 202R is reflected from the first interface 106A between the first layer and the second layer, the green component 202G is reflected from the second interface 106B between the second layer and the third layer and the blue component 202B is reflected from the surface of the third layer.

The first in-coupling diffractive means 108 can be configured to optimize, or substantially optimize, the diffraction angle for the red component 202R and/or the green component 202G but does not need to be optimized, or substantially optimized for the blue component 202B. This can enable more efficient in-coupling of the red and green light.

The second in-coupling diffractive means 114 is positioned so that light that is incident on the first in-coupling diffractive means 108 and passes through the stack of layers 104 is incident on the second in-coupling diffractive means 114. In this example the zeroth (T₀) order 204B is incident on the second in-coupling diffractive means 114.

FIG. 3A only shows the blue component 204B of the zeroth (T₀) order that is incident on the second in-coupling diffractive means 114. It is noted that the incoupling efficiency is never perfect and so some red and green light would pass through the stack of layers 104 and be incident on the second in-coupling diffractive means 114. The red component and the green component that would be incident on the second in-coupling diffractive means 114 are shown in FIGS. 3B and 3C.

The second in-coupling diffractive means 114 is configured so that incident the zeroth (T₀) order is diffracted to an angle to enable total internal reflection within the light guiding member 102. The second in-coupling diffractive means 114 can be optimized for the in-coupling of light in a second wavelength range. In this example the second in-coupling diffractive means 114 can be optimized for blue light. This can allow for efficient in-coupling of blue light.

The blue light that is in-coupled by the second in-coupling diffractive means 114 passes through the layers of the light guiding member 102 and is expanded by the expanding diffractive means 110 and out-coupled by the out-coupling diffractive means 112.

The light guiding member 102 is configured so that the out-coupled expanded beam of light can be viewed by a user of the apparatus 100. The out-coupled expanded beams of light provide a virtual image that can be observed by a user. The out-coupled beam of light therefore provides an expanded exit pupil. The first in-coupling diffractive means 108 defines an entrance pupil for the light guiding member 102 mainly for light in a first wavelength range and to a lesser extent for light in a second wavelength range and the second in-coupling diffractive means 114 defines an entrance pupil for the light guiding member 102 mainly for light in the second wavelength range and to a lesser extent for light in the first wavelength range. In this case the first in-coupling diffractive means 108 defines an entrance pupil for the light guiding member 102 for red and green light and the second in-coupling diffractive means 114 defines an entrance pupil for the light guiding member 102 for blue light.

The expanding diffractive means 110 and the out-coupling diffractive means 112 replicate the pupils in two directions so, that the out-coupled beam of light comprises many overlapping exit pupils.

The use of the two in-coupling diffractive means 108, 114 can improve the efficiency of the in-coupling of light. The respective in-coupling diffractive means 108, 114 can be designed or optimized for in-coupling different wavelengths of right. This can improve the brightness and uniformity of the output of the apparatus. The use of the second in-coupling diffractive means 114 for the in-coupling of light in a second wavelength range can increase the number of overlapping pupils in the output of the apparatus 100 and can reduce fringing or dark bands in the output.

FIGS. 3A to 3C show in-coupling of different wavelengths of light into an example apparatus 100 by the second in-coupling diffractive means 114.

FIG. 3A shows the in-coupling of blue light by the second in-coupling diffractive means 114. The blue component of the input beam of light 200B is incident on the first in-coupling diffractive means 108. The blue component 204B of the zeroth order passes through the stack of layers 104 and is incident on the second in-coupling diffractive means 114. The second in-coupling diffractive means 114 diffracts the blue component 204B back into the stack of layers 104.

The angle at which the second in-coupling diffractive means 114 diffracts the blue component 204B back into the stack of layers 104 and the optical properties of the layers and interfaces 106 are configured so that the blue component 204B passes through all of the layers in the stack 104. The blue component 204B is guided through the light guiding member 102 via internal reflections. The blue component 204B can be reflected from the surfaces of the outer layers in the stack of layers 104. The internal reflections of the blue component would be incident on the expanding diffractive means 110 and the out-coupling diffractive means 112. This enables the blue light in-coupled by the second in-coupling diffractive means 114 to be comprised in the out-coupled beam of light.

FIG. 3B shows the in-coupling of green light by the second in-coupling diffractive means 114. The green component of the input beam of light 200G is incident on the first in-coupling diffractive means 108. The green component 204G of the zeroth order passes through the stack of layers 104 and is incident on the second in-coupling diffractive means 114. The second in-coupling diffractive means 114 diffracts the green component 204G back into the stack of layers 104.

The angle at which the second in-coupling diffractive means 114 diffracts the green component 204G back into the stack of layers 104 and the optical properties of the layers and interfaces 106 are configured so that the green component 204G does not pass through all of the layers in the stack 104. In this example, the green component 204G is reflected from the interface between the third layer and the second layer. The diffracted green component 204G therefore remains in the third layer and is not incident on the expanding diffractive means 110 and the out-coupling diffractive means 112. The green light in-coupled by the second in-coupling diffractive means 114 is not comprised in the out-coupled beam of light from the out-coupling diffractive means.

Similarly, FIG. 3C shows the in-coupling of red light by the second in-coupling diffractive means 114. The red component of the input beam of light 200R is also incident on the first in-coupling diffractive means 108. The red component 204R of the zeroth order also passes through the stack of layers 104 and is incident on the second in-coupling diffractive means 114. The second in-coupling diffractive means 114 diffracts the red component 204R back into the stack of layers 104.

The angle at which the second in-coupling diffractive means 114 diffracts the red component 204R back into the stack of layers 104 and the optical properties of the layers and interfaces 106 are configured so that the red component 204R does not pass through all of the layers in the stack 104. In this example, the red component 204R is reflected from the interface between the third layer and the second layer. The diffracted red component 204R therefore remains in the third layer and is not incident on the expanding diffractive means 110 and the out-coupling diffractive means 112. The red light in-coupled by the second in-coupling diffractive means 114 is not comprised in the out-coupled beam of light from the out-coupling diffractive means.

FIGS. 4A to 4C show an example apparatus 100 and an optical path for the example apparatus 100. The example apparatus 100 comprises a light guiding member 102 comprising a stack of layers 104. The apparatus 100 also comprises a first in-coupling diffractive means 108, an expanding diffractive means 110, an out-coupling diffractive means 112 and a second in-coupling diffractive means 114. These can be as shown in FIGS. 1 to 3C. Corresponding reference numerals are used for corresponding features.

FIG. 4A shows an example lay out for the first in-coupling diffractive means 108, the expanding diffractive means 110, and the out-coupling diffractive means 112.

In the example of FIG. 4A the first in-coupling diffractive means 108 has a circular shape. Other shapes could be used for the first in-coupling diffractive means 108 in other examples. In the example of FIG. 4A the first in-coupling diffractive means 108 has a vertical diffractive grating. Other arrangements for the first in-coupling diffractive means 108 could be used in other examples.

The expanding diffractive means 110 is positioned within the light guiding means 102 so that the in-coupled beam of light is provided from the first in-coupling diffractive means 108 to the expanding diffractive means 110. In the example shown in FIG. 4A the expanding diffractive means 110 comprises gratings which expands the beam of light in a first direction.

The out-coupling diffractive means 112 is positioned within the light guiding means 102 so that the expanded beam of light from the expanding diffractive means 110 is provided to the out-coupling diffractive means 112. In the example shown in FIG. 4A out-coupling diffractive means 112 comprises gratings which expands the beam of light in a second direction where the second direction is perpendicular, or substantially perpendicular, to the first direction.

FIG. 4B shows a cross section of the apparatus 100. FIG. 4B shows the stack of layers 104 and the relative positions of the first in-coupling diffractive means 108 and the second in-coupling diffractive means 114. The second in-coupling diffractive means 114 is located in the light guiding means 102 so that the second in-coupling diffractive means 114 at least partially overlaps with the first in-coupling diffractive means 108.

The second in-coupling diffractive means 114 can comprise a grating that is in the same orientation as the first in-coupling diffractive means 108. In this example the first in-coupling diffractive means 108 has a vertical diffraction grating and so the second in-coupling diffractive means 114 also has a vertical diffraction grating. Other orientations for the grating can be used in other examples.

FIG. 4C represents the optical path for a beam of light through the apparatus 100.

At block 400 light is emitted from a picture generating unit or any other suitable light source. The apparatus 100 can be positioned so that the light from the picture generating unit is incident on the apparatus 100. The picture generating unit is not shown in FIG. 4A or 4B.

At block 402 some light is incoupled by the first in-coupling diffractive means 108. This light can comprise light in a first wavelength range that is then propagated through the light guiding member. The first wavelength range could comprise red light and green light.

At block 404 some light is incoupled by the second in-coupling diffractive means 108. This light is light that has passed through the stack of layers 104 of the light guiding member. This light can comprise light in a second wavelength range that is then propagated through the light guiding member 102. The second wavelength range could comprise blue light.

At block 406 the light that has been incoupled by the first in-coupling diffractive means 108 and the light that has been incoupled by the second in-coupling diffractive means 114 is provided to the expanding diffractive means 110. The light that is incident on the expanding diffractive means 110 can comprise light from the first wavelength range that has been incoupled by the first in-coupling diffractive means 108 and light from the second wavelength range that has been incoupled by the second in-coupling diffractive means 114.

At block 408 the light that has been expanded by the expanding diffractive means 110 is provided to the out-coupling diffractive means 112. The out-coupling diffractive means 112 expands the light in a second direction and out-couples the light from the light guiding member 102.

This provides out-coupled light with a more uniform brightness and reduced dark fringes.

FIGS. 5A to 5C show another example apparatus 100 and an optical path for the example apparatus 100. The example apparatus 100 comprises a light guiding member 102 comprising a stack of layers 104. The apparatus 100 also comprises a first in-coupling diffractive means 108, a first expanding diffractive means 110A, a second expanding diffractive means 110B, an out-coupling diffractive means 112, a second in-coupling diffractive means 114 and a third in-coupling diffractive means 500. Corresponding reference numerals from earlier figs. are used for corresponding features.

FIG. 5A shows an example lay out for the first in-coupling diffractive means 108, the first expanding diffractive means 110A and the second expanding diffractive means 110B, and the out-coupling diffractive means 112.

In the example of FIG. 5A the first in-coupling diffractive means 108 has a circular shape. Other shapes could be used for the first in-coupling diffractive means 108 in other examples. In the example of FIG. 5A the first in-coupling diffractive means 108 has a vertical diffractive grating. Other arrangements for the first in-coupling diffractive means 108 could be used in other examples.

In the example of FIG. 5A the first in-coupling diffractive means 108 is located in a central position on a first surface of the light guiding means 102. The first in-coupling diffractive means 108 could be located in other locations in other examples.

The first expanding diffractive means 110A and the second expanding diffractive means 110B are positioned within the light guiding means 102 so that the in-coupled beam of light is provided from the first in-coupling diffractive means 108 to the first expanding diffractive means 110A and the second expanding diffractive means 110B. Some of the input beam of light is provided from the first in-coupling diffractive means 108 to the first expanding diffractive means 110A and some of the input beam of light is provided from the first in-coupling diffractive means 108 to the second expanding diffractive means 110B. In the example of FIG. 4A equal parts, or substantially equal parts, of the input beams are provided to the respective expanding diffractive means 110A, 110B.

The first expanding diffractive means 110A is provided on a first side of the first in-coupling means 108 and the second expanding diffractive means 110B is provided on a second side of the first in-coupling means 108. In the example of FIG. 4A the first expanding diffractive means 110A is provided on the left hand side of the first in-coupling diffractive means 108 and the second expanding diffractive means 110B is provided on the right hand side of the first in-coupling diffractive means 108. In the example of FIG. 4A the first expanding diffractive means 110A is symmetrical to the second expanding diffractive means 110B. Other arrangements can be used in other examples.

The expanding diffractive means 110A, 110B comprise gratings which expand the beam of light in a first direction.

The out-coupling diffractive means 112 is positioned within the light guiding means 102 so that the expanded beam of light from the respective expanding diffractive means 110A, 110B is provided to the out-coupling diffractive means 112. In the example shown in FIG. 4A out-coupling diffractive means 112 comprises gratings which expands the beam of light in a second direction where the second direction is perpendicular, or substantially perpendicular, to the first direction.

The expanded beams of light from the expanding diffractive means 110A, 110B are provided to edge regions of the out-coupling diffractive means 112. The edge regions can comprise regions of the out-coupling diffractive means 112 that are underneath the expanding diffractive means 110A, 110B but that are not underneath the first in-coupling diffractive means 108. Light from the first expanding diffractive means 110A is incident on a first edge region and light from the second expanding diffractive means 110B is incident on a second edge region. In this example the first region comprises a region towards the left hand side of the out-coupling diffractive means 112 and the second region comprises a region towards the right hand side of the in-coupling diffractive means 112.

FIG. 5B shows a cross section of the apparatus 100. FIG. 5B shows the stack of layers 104 and the relative positions of the first in-coupling diffractive means 108 and the second in-coupling diffractive means 114 and a third in-coupling diffractive means 500.

The second in-coupling diffractive means 114 is located in the light guiding means 102 so that the second in-coupling diffractive means 114 at least partially overlaps with the first in-coupling diffractive means 108. The second in-coupling diffractive means 114 can be arranged as shown in the examples of FIGS. 4A to 4C.

The third in-coupling diffractive means 500 is provided in a different plane of the light guiding means 102 to the first in-coupling diffractive means 108 and the second in-coupling diffractive means 114.

The third in-coupling diffractive means 500 is located in the light guiding means 102 so that the third in-coupling diffractive means 500 at least partially overlaps with the first in-coupling diffractive means 108 and the second in-coupling diffractive means 114.

The third in-coupling diffractive means 500 can comprise a diffractive grating that is arranged in a perpendicular orientation to the diffractive grating of the first in-coupling diffractive means 108 and the second in-coupling diffractive means 114. In this example the third in-coupling diffractive means 500 has a horizontal diffractive grating. Other arrangements for the respective in-coupling diffractive means 108, 114, 500 could be used in other examples.

The diffractive grating used for the third in-coupling diffractive means 500 can have the same period as the diffractive gratings used for the first in-coupling diffractive means 108 and the second in-coupling diffractive means 114.

The third in-coupling diffractive means 500 is provided on a different surface to the first in-coupling diffractive means 108, the first expanding diffractive means 110A, the second expanding diffractive means 110B and the out-coupling diffractive means 112. The third in-coupling diffractive means 500 is provided on a different surface within the stack of layers 104 to the second in-coupling diffractive means 114. The third in-coupling diffractive means 500 can be provided on the first layer of the stack of layers 104 so that light of both the first wavelength range and the second wavelength range that is in-coupled by the third in-coupling diffractive means 500 is reflected within the first layer.

The in-coupled beam of light from the third in-coupling diffractive means 500 is provided to the out-coupling diffractive means 112. The in-coupled beam of light from the third in-coupling diffractive means 500 can be provided to a central region of the out-coupling diffractive means 112. The central region of the out-coupling diffractive means 112 can be positioned underneath the first in-coupling diffractive means 108. Therefore, the out-coupling diffractive means 112 is configured to outcouple both light from the expanding diffractive means 110A, 110B and light from the third in-coupling diffractive means 500.

The use of the two expanding means 110A, 110B enables both the input beam of light that is directed towards the right hand side and the input beam of light that is directed to the left hand side to be expanded and used. This provides for an efficient apparatus 100.

Further, the use of the third in-coupling diffractive means 500 enables light to be provided to a central region of the out-coupling diffractive means 112. This can reduce a dark band that might otherwise be visible in the output. This can provide for a more uniform output.

FIG. 5C represents the optical path for a beam of light through the apparatus 100 shown in FIGS. 5A and 5B.

At block 502 light is emitted from a picture generating unit or any other suitable light source. The apparatus 100 can be positioned so that the light from the picture generating unit is incident on the apparatus 100. The picture generating unit is not shown in FIG. 5A or 5B.

At block 504 some light is incoupled by the first in-coupling diffractive means 108. This light can comprise light in a first wavelength range that is then propagated through the light guiding member 102. The first wavelength range could comprise red light and green light.

At block 506 some light is incoupled by the second in-coupling diffractive means 114. This light is light that has passed through the stack of layers 104 of the light guiding member 102. This light can comprise light in a second wavelength range that is then propagated through the light guiding member 102. The second wavelength range could comprise blue light.

At block 508 some light is incoupled by the third in-coupling diffractive means 500. The light that is incoupled by the third in-coupling diffractive means 500 is in-coupled in a direction that is perpendicular, or substantially perpendicular, to the light that is incoupled by the first in-coupling diffractive means 108 and the second in-coupling diffractive means 114.

At block 510 some of the light that has been incoupled by the first in-coupling diffractive means 108 and the second in-coupling diffractive means 114 is provided to the first expanding diffractive means 110A. Similarly, at block 512 some of the light that has been incoupled by the first in-coupling diffractive means 108 and the second in-coupling diffractive means 114 is provided to the second expanding diffractive means 110B.

At block 514 the light that has been expanded by the first expanding diffractive means 110 A and the light that has been expanded by the second expanding diffractive means 110B is provided to the out-coupling diffractive means 112. Light that has been incoupled by the third in-coupling diffractive means 500 is also provided to the out-coupling diffractive means 112. The light from the third in-coupling diffractive means 500 is not expanded by the expanding diffractive means 110A, 110B.

The out-coupling diffractive means 112 expands the light in a second direction and out-couples the light from the light guiding member 102.

FIGS. 6A to 6C show another example apparatus 100 and an optical path for the example apparatus 100. The example apparatus 100 comprises a first in-coupling diffractive means 108, a first expanding diffractive means 110A, a second expanding diffractive means 110B, a first out-coupling diffractive means 112A, a second in-coupling diffractive means 114 and a third in-coupling diffractive means 500. These can be provided on a first stack of layers 104A. Corresponding reference numerals from earlier figs. are used for corresponding features.

The apparatus 100 of FIGS. 6A to 6C differs from the apparatus of FIGS. 5A to 5C in that the third in-coupling diffractive means 500 is provided on a second stack of layers 104B. Also the apparatus 100 comprises a second out-coupling diffractive means 112B.

The second out-coupling diffractive means 112B is positioned within the light guiding means 102 so that the in-coupled beams of light from the third in-coupling diffractive means 500 are provided to the second out-coupling diffractive means 112B. For example, the second out-coupling diffractive means 112B can be positioned underneath the third in-coupling diffractive means 500 so that light in-coupled from the third in-coupling diffractive means 500 is provided to second out-coupling diffractive means 112B.

The second out-coupling diffractive means 112B can be arranged as a trapezoid underneath the third in-coupling diffractive means 500. The trapezoid is narrower at the end closest to the third in-coupling diffractive means 500. Other shapes can be used in other examples. Other shapes or arrangements could be used in other examples.

The second out-coupling diffractive means 112B comprises grating lines which are parallel to the grating lines of the first out-coupling diffractive means 112B. The diffractive grating used in the second out-coupling diffractive means 112B can have the same period, orientation, and/or any other parameters, as the diffractive gratings used for the first out-coupling diffractive means 112A.

FIG. 6B shows a cross section of the apparatus 100. This shows the respective stacks of layers 104A, 104B and the relative positions of the respective in-coupling diffractive means 108, 114, 500 and out-coupling diffractive means 112A, 112B. In this example the third in-coupling diffractive means 500 and the second out-coupling diffractive means 112B are provided on a second stack of layers 104B. The second stack of layers 104B comprises the same number of layers as the first stack of layers 104A. The second stack of layers 104B can comprise three layers or any other suitable number of layers. The arrangement of the layers within the second stack of layers 104B can be the same as in the first stack of layers 104A, for example the same thicknesses of layers and the same type of materials could be used of the respective arrangements could be different.

The first stack of layers 104A and the second stack of layers 104B can be combined to provide the apparatus 100. The first stack of layers 104A and the second stack of layers 104B are arranged adjacent to each other. The first stack of layers 104A and the second stack of layers 104B are arranged so that the first in-coupling diffractive means 108 and the third in-coupling diffractive means 500 are adjacent to each other. The first stack of layers 104A and the second stack of layers 104B are arranged so that the surfaces on which the respective out-coupling diffractive means 112A, 112B are provided are facing each other. In this case, once the first stack of layers 104A and the second stack of layers 104B are combined, the first in-coupling diffractive means 108 and the out-coupling diffractive means 112A, 112B are provided on internal surfaces of the light guiding means 102.

FIG. 6C represents the optical path for a beam of light through the apparatus 100 shown in FIGS. 6A and 6B.

At block 600 light is emitted from a picture generating unit or any other suitable light source. The apparatus 100 can be positioned so that the light from the picture generating unit is incident on the apparatus 100. The picture generating unit is not shown in FIG. 6A or 6B.

At block 602 some light is incoupled by the first in-coupling diffractive means 108. This light can comprise light in a first wavelength range that is then propagated through the light guiding member 102. The first wavelength range could comprise red light and green light.

At block 604 some light is incoupled by the second in-coupling diffractive means 114. This light is light that has passed through the first stack of layers 104A of the light guiding member. This light can comprise light in a second wavelength range that is then propagated through the light guiding member 102. The second wavelength range could comprise blue light.

At block 606 some light is incoupled by the third in-coupling diffractive means 500. The light that is incoupled by the third in-coupling diffractive means 500 is in-coupled in a direction that is perpendicular, or substantially perpendicular, to the light that is incoupled by the first in-coupling diffractive means 108 and the second in-coupling diffractive means 114.

At block 608 some of the light that has been incoupled by the first in-coupling diffractive means 108 and the second in-coupling diffractive means 114 is provided to the first expanding diffractive means 110A. Similarly, at block 610 some of the light that has been incoupled by the first in-coupling diffractive means 108 and the second in-coupling diffractive means 114 is provided to the second expanding diffractive means 110B.

At block 612 the light that has been expanded by the first expanding diffractive means 110 A and the light that has been expanded by the second expanding diffractive means 110B is provided to the first out-coupling diffractive means 112A.

At block 614 light that has been incoupled by the third in-coupling diffractive means 500 is provided to the second out-coupling diffractive means 112B. The light from the third in-coupling diffractive means 500 is not expanded by the expanding diffractive means 110A, 110B.

The respective out-coupling diffractive means 112A, 112B out-couple the light from the light guiding member 102.

FIGS. 7A to 7C show another example apparatus 100 and an optical path for the example apparatus 100. This is similar to the example apparatus 100 shown in FIGS. 6A to 6C but in the apparatus comprises a fourth in-coupling diffractive means 700.

The fourth in-coupling diffractive means 700 is provided on a different surface to the second stack of layers 104B to the third in-coupling diffractive means 500. In this example the third in-coupling diffractive means 500 can be provided on the first layer of the second stack of layers 104B and the fourth in-coupling diffractive means 700 is provided on a third layer of the second stack of layers 104B.

The third in-coupling diffractive means 500 and the fourth in-coupling diffractive means 700 can be optimized or substantially optimized for in-coupling different wavelengths of light. For examples the third in-coupling diffractive means 500 can be configured to in-couple light in a first wavelength range and the fourth in-coupling diffractive means 700 can be configured to in-couple light in a second wavelength range. The respective wavelength ranges can be the same as for the first in-coupling diffractive means 108 and the second in-coupling diffractive means 114. FIG. 6C represents the optical path for a beam of light through the apparatus 100 shown in FIGS. 6A and 6B.

FIG. 7C represents the optical path for a beam of light through the apparatus 100 shown in FIGS. 7A and 7B.

At block 702 light is emitted from a picture generating unit or any other suitable light source. The apparatus 100 can be positioned so that the light from the picture generating unit is incident on the apparatus 100. The picture generating unit is not shown in FIG. 7A or 7B.

At block 704 some light is incoupled by the first in-coupling diffractive means 108. This light can comprise light in a first wavelength range that is then propagated through the light guiding member 102. The first wavelength range could comprise red light and green light.

At block 706 some light is incoupled by the second in-coupling diffractive means 114. This light is light that has passed through the first stack of layers 104A of the light guiding member. This light can comprise light in a second wavelength range that is then propagated through the light guiding member 102. The second wavelength range could comprise blue light.

At block 708 some light is incoupled by the third in-coupling diffractive means 500. The light that is incoupled by the third in-coupling diffractive means 500 is in-coupled in a direction that is perpendicular, or substantially perpendicular, to the light that is incoupled by the first in-coupling diffractive means 108 and the second in-coupling diffractive means 114. The light that is incoupled by the third in-coupling diffractive means 500 can comprise light in a first wavelength range that is then propagated through the light guiding member 102. The first wavelength range could comprise red light and green light.

At block 710 some light is incoupled by the fourth in-coupling diffractive means 700. The light that is incoupled by the third in-coupling diffractive means 700 is in-coupled in a direction that is perpendicular, or substantially perpendicular, to the light that is incoupled by the first in-coupling diffractive means 108 and the second in-coupling diffractive means 114. The light that is incoupled by the third in-coupling diffractive means 700 is in-coupled in a direction that is parallel, or substantially parallel, to the light that is incoupled by the third in-coupling diffractive means 500. The light that is incoupled by the fourth in-coupling diffractive means 700 can comprise light in a second wavelength range that is then propagated through the light guiding member 102. The second wavelength range could comprise blue light.

At block 712 some of the light that has been incoupled by the first in-coupling diffractive means 108 and the second in-coupling diffractive means 114 is provided to the first expanding diffractive means 110A. Similarly, at block 714 some of the light that has been incoupled by the first in-coupling diffractive means 108 and the second in-coupling diffractive means 114 is provided to the second expanding diffractive means 110B.

At block 716 the light that has been expanded by the first expanding diffractive means 110 A and the light that has been expanded by the second expanding diffractive means 110B is provided to the first out-coupling diffractive means 112A.

At block 718 light that has been incoupled by the third in-coupling diffractive means 500 and the fourth in-coupling diffractive means 700 is provided to the second out-coupling diffractive means 112B. The light from the third in-coupling diffractive means 500 and the fourth in-coupling diffractive means 700 is not expanded by the expanding diffractive means 110A, 110B.

The respective out-coupling diffractive means 112A, 112B out-couple the light from the light guiding member 102.

FIG. 8 shows an example diffraction grating profile 800 for a diffraction grating and a representation of some of the parameters that can be adjusted for the different diffractive means. The adjustment of the diffraction grating profile 800 can improve the efficiency at which selected wavelengths of light can be in-coupled.

The diffraction grating comprises a sequence of ridges 802 and grooves 804. The ridges 802 and the grooves 804 are provided on a surface of a substrate 806. The substrate 806 could be one of the layers in the light guide.

The diffraction grating profile 800 in FIG. 8 comprises a rectangular cross section for the ridges 802 and grooves 804. Other shapes for the ridges 802 and grooves 804 can be used in other examples, as shown in FIGS. 9A to 9E.

FIG. 8 shows example parameters that can be adjusted, these comprise:

$$a = ridge width ( top )$$

$$b = ridge width ( bottom )$$

$$c = groove width$$

$$d = grating period$$

$$h = grating depth$$

$$f = \frac{c}{d} = fill ratio$$

other parameters could be adjusted in other examples.

FIGS. 9A to 9E show some diffraction grating profile examples that can be used for the diffractive means in examples of the disclosure.

In FIG. 9A the diffraction grating profile 800 comprises a binary grating profile. The binary grating profile comprise ridges 802 and grooves 804 with rectangular cross sections.

The ridges 802 and grooves 804 have symmetrical cross sections. The ridges 802 have the same width at the top and the bottom.

FIG. 9A shows a beam of light 900 with normal incidence on the diffraction grating profile 800. In this case the diffraction by the grating 800 is symmetric (for light with normal incidence) so that the T₋₁ order 902 and the T₁ order 904 have the same intensity. This is represented in FIG. 9A by the arrows representing the T₋₁ order 902 and the T₁ order 904 having the same width. Also the T₋₁ order 902 and the T₁ order 904 are symmetrical about the normal 906, that is they are diffracted at the same angle from the normal 906.

In FIG. 9B the diffraction grating profile 800 comprises a trapezoid grating profile. The trapezoid grating profile comprise ridges 802 and grooves 804 with trapezoid cross sections. The ridges 802 and grooves 804 have symmetrical cross sections. The ridges 802 have a larger width at the top than at the bottom.

FIG. 9B also shows a beam of light 900 with normal incidence on the diffraction grating profile 800. In this case the diffraction by the grating 800 is symmetric (for light with normal incidence) so that the T₋₁ order 902 and the T₁ order 904 have the same intensity. This is represented in FIG. 9B by the arrows representing the T₋₁ order 902 and the T₁ order 904 having the same width. Also the T₋₁ order 902 and the T₁ order 904 are symmetrical about the normal 906, that is they are diffracted at the same angle from the normal 906.

In FIG. 9C the diffraction grating profile 800 comprises a blazed grating profile. The blazed grating profile comprise ridges 802 and grooves 804 with blazed cross sections. In the blazed cross section the ridges 802 have a wall that is inclined at an angle to the normal 906 and a wall that is parallel to the normal 906.

FIG. 9C also shows a beam of light 900 with normal incidence on the diffraction grating profile 800. In this case the diffraction by the grating 800 is not symmetric (for light with normal incidence) so that the T₋₁ order 902 and the T₁ order 904 have different intensities.

The order travelling away from the direction of the slant of the ridges has the higher intensity. In this example the T₁ order 904 has the higher intensity. This is represented in FIG. 9C by the arrows representing the T₋₁ order 902 and the T₁ order 904 having different widths. The arrow representing the T₁ order 904 has the thicker width to indicate it has the higher intensity.

In FIG. 9D the diffraction grating profile 800 comprises a multi-step grating profile. The multi-step grating profile comprise ridges 802 with a staircase topology. This can be used as an approximation of a blazed grating profile.

FIG. 9D also shows a beam of light 900 with normal incidence on the diffraction grating profile 800. In this case the diffraction by the grating 800 is not symmetric (for light with normal incidence) so that the T₋₁ order 902 and the T₁ order 904 have different intensities. The order travelling away from the direction of the staircase has the higher intensity. In this example the T₁ order 904 has the higher intensity. This is represented in FIG. 9D by the arrows representing the T₋₁ order 902 and the T₁ order 904 having different widths. The arrow representing the T₁ order 904 has the thicker width to indicate it has the higher intensity.

In FIG. 9E the diffraction grating profile 800 comprises a slanted overhanging grating profile. The slanted overhanging grating profile comprise ridges 802 which has two slanted sides.

FIG. 9E also shows a beam of light 900 with normal incidence on the diffraction grating profile 800. In this case the diffraction by the grating 800 is not symmetric (for light with normal incidence) so that the T₋₁ order 902 and the T₁ order 904 have different intensities. The order travelling away from the direction of the slant has the higher intensity. In this example the T₁ order 904 has the higher intensity. This is represented in FIG. 9D by the arrows representing the T₋₁ order 902 and the T₁ order 904 having different widths. The arrow representing the T₁ order 904 has the thicker width to indicate it has the higher intensity.

The slanted overhanging grating profile can be optimized, or substantially optimized, for a particular wavelength by adjusting the slanting angle

$$φ = \frac{{φ}_{1} + {φ}_{2}}{2} ,$$

adjusting the grating depth h, adjusting the fill ratio f, or adjusting any other suitable parameter.

FIG. 10 shows an example luminance distribution that can be obtained using examples of the disclosure. In the example of FIG. 10 the first plot 1000 represents the luminance distribution of light out-coupled by the out-coupling diffractive means 112 in an apparatus that comprises a first in-coupling diffractive means 108 but not a second in-coupling diffractive means.

The second plot 1002 represent the luminance of light that has been in-coupled by the second in-coupling diffractive means 114 and out-coupled bu the out-coupling diffractive means 112.

The area in the dashed circle 1004 shows the ripple effect. This could result in dark fringes in the output due to insufficient overlap of exit pupils. One or both of the in-coupling diffractive means 108, 114 can be designed to reduce the ripple effect.

For example, the second in-coupling diffractive means 114 can be optimized for in-coupling blue light so that the first in-coupling diffractive means 108 can be optimized for in-coupling red and green light without having to compromise ti account for blue light. This can result in increased in-coupling efficiencies for all three primary colours.

The respective in-coupling diffractive means 108, 114 can be designed so that the peaks of the ripple effect caused by light light in-coupled by the first in-coupling diffractive means 108 and the troughs of the ripple effect caused by light light in-coupled by the second in-coupling diffractive means 114 are aligned. This can reduce the overall ripple effect and provide a more unform output.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to ‘comprising only one . . . ’ or by using ‘consisting.’

In this description, the wording ‘connect’, ‘couple’ and ‘communication’ and their derivatives mean operationally connected/coupled/in communication. It should be appreciated that any number or combination of intervening components can exist (including no intervening components), i.e., to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database, or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’, or ‘may’ refers to a particular instance in a class of examples. A property of the instance can be a property of only that instance or a property of the class or a property of a sub-class of the class that includes some but not all the instances in the class. It is therefore implicitly disclosed that a feature described with reference to one example but not with reference to another example, can where possible be used in that other example as part of a working combination but does not necessarily have to be used in that other example.

As used herein, “at least one of the following:” and “at least one of” and similar wording, where the list of two or more elements are joined by “and” or “or” mean at least any one of the elements, or at least any two or more of the elements, or at least all the elements.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

The description of a feature, such as an apparatus or a component of an apparatus, configured to perform a function, or for performing a function, should additionally be considered to also disclose a method of performing that function. For example, description of an apparatus configured to perform one or more actions, or for performing one or more actions, should additionally be considered to disclose a method of performing those one or more actions with or without the apparatus.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance the Applicant may seek protection via the claims in respect of any patentable feature or combination of features hereinbefore referred to and/or shown in the drawings whether or not emphasis has been placed thereon.

I/We claim:

1. An apparatus comprising:
a light guide arranged to enable light to be guided through the light guide via internal reflections;
first in-coupling diffractive means configured to in-couple one or more input beams of light with a first wavelength range into the light guide;
second in-coupling diffractive means configured to in-couple one or more input beams of light with a second wavelength range into the light guide;
expanding diffractive means configured to expand the one or more input beams of light; and
out-coupling diffractive means configured to out-couple the expanded beams of light from the light guide so as to provide a first exit pupil for the first wavelength range and a second exit pupil for the second wavelength range.

2. The apparatus as claimed in claim 1, wherein the first wavelength range comprises a visible wavelength range and the second wavelength range comprises an invisible wavelength range.

3. The apparatus as claimed in claim 2, wherein the invisible light comprises infra-red light.

4. The apparatus as claimed in claim 1, wherein the position of at least one of the first exit pupil or the second exit pupil is adjustable.

5. The apparatus as claimed in claim 1, wherein the first exit pupil and the second exit pupil are at least partially overlapping.

6. The apparatus as claimed in claim 1 wherein the light with the second wavelength range is provided as at least one of:
structured light;
a grid; or
a beam.

7. The apparatus as claimed in claim 1, wherein the light with the second wavelength range is arranged for illuminating one or more objects near the apparatus.

8. The apparatus as claimed in claim 1, wherein the first in-coupling diffractive means and the second in-coupling diffractive means have at least one of:
different fill ratio;
different depth;
different period;
different slant angles; or
different materials.

9. The apparatus as claimed in claim 1, wherein the light guide comprises a stack of layers and multiple interfaces between respective layers, wherein the respective layers are arranged to enable light to be guided through the light guide via internal reflections.

10. The apparatus as claimed in claim 9, wherein a thin film material is provided at the interfaces.

11. The apparatus as claimed in claim 1, wherein the first in-coupling diffractive means and the second in-coupling diffractive means are provided on a same surface of the light guide.

12. The apparatus as claimed in claim 11, wherein the first in-coupling diffractive means and the second in-coupling diffractive means are provided adjacent each other.

13. The apparatus as claimed in claim 1, wherein the first in-coupling diffractive means and the second in-coupling diffractive means are provided on different surfaces of the light guide.

14. The apparatus as claimed in claim 13, wherein the second in-coupling diffractive means is provided at least partially overlapping the first in-coupling diffractive means.

15. The apparatus as claimed in claim 1, wherein the apparatus comprises a third in-coupling diffractive means configured to in-couple light within the first wavelength range that has passed through at least part of the light guide.

16. The apparatus as claimed in claim 1, wherein the apparatus comprises a first image generating unit configured to provide the one or more input beams of light with a first wavelength range and a second image generating unit configured to provide the one or more input beams of light with a second wavelength range.

17. The apparatus as claimed in claim 16, wherein at least one of the first image generating unit and the second image generating unit is adjustable to enable a position of an image to be adjusted.

18. The apparatus as claimed in claim 17, further comprising:
at least one processor; and
at least one memory including computer program code;
the at least one memory storing instructions that, when executed by the at least one processor, cause the apparatus to:
adjust the first image generating unit and the second image generating unit to enable the position of an image to be adjusted.

19. The apparatus as claimed in claim 16, wherein the respective image generating units comprise one or more of:
reflective liquid crystal on silicon;
spatial light modulator;
digital micromirror device; or
digital light processing.

20. A module, a device, a vehicle or cab for a vehicle comprising an apparatus as claimed in claim 1.
